(19) United States
(12) Patent Application Publication
(10) Pub. No.: US 2026/0311256 A1
(43) Pub. Date: Oct. 8, 2026

(54) Methods and systems for preventing fraud in trade receivables financings

(71) Applicant: Joseph Oliver, Chicago, IL (US)

(72) Inventor: Joseph Oliver, Chicago, IL (US)

(73) Assignee: Incuvent LLC, Chicago, IL (US)

(21) Appl. No.: 19/172,710

(22) Filed: Apr. 8, 2025

(51) Int. Cl. G06Q 40/06; G06Q 30/018

(52) U.S. Cl. CPC G06Q 40/06; G06Q 30/0185

(57) ABSTRACT

Methods and systems for assessing the risk of seller-based fraud in trade receivables financings are discussed. In Section 1, we present the Application, Scoring, and Approval Process and the various asset classes and transaction types. In Section 2, we present the Risk Categories of the Application. In Section 3, we present the Value Table for Applicant Scoring. In Section 4, we present Thresholding for Approving Applicants. Other embodiments, features, and aspects of the disclosed system are described in detail herein and are considered a part of the claimed disclosed system.

### FIELD

This invention relates generally to risk assessment, and more particularly, for methods and systems to prevent fraud in connection with trade receivables financing transactions.

### BACKGROUND

More and more financiers are turning to trade finance as an alternative asset class offering consistent returns, low credit volatility, and diversification. UN Trade and Development (UNCTAD) reported that annual global trade hit an all-time record of $33 trillion in 2024. Yet, Porter Capital estimates that the trade receivables finance market only accounted for around $3 trillion of that value, showing a massive disparity between overall trade volume and the financing market supporting it. The primary reason for this gap is attributed to fraud. Common schemes include sellers exaggerating receivables value, submitting fake invoices, and colluding with its receivables obligors to overstate amounts and split the proceeds. Public companies and large corporations dominate the existing trade receivables finance market due to the disclosure requirements of public companies and the significant reputational risk of fraud. This leaves out the much larger portion of the market consisting of private companies that do not offer the same transparency as their public counterparts. While Know Your Customer and Anti-Money Laundering checks attempt to establish credibility with a company, they are typically manual, time-consuming, and do not evaluate the risk associated with a company's ability to perform its obligations in a trade receivables financing. Further, conventional credit checks assess a company's likelihood of meeting its financial obligations, but do not address performance risk. Invoice authentication systems, in a similar realm, flag suspicious documentation without considering risks specific to the company.

### SUMMARY

Methods and systems for assessing the risk of seller-based fraud in trade receivables financings are discussed. In Section 1, we present the Application, Scoring, and Approval Process and the various asset classes and transaction types. In Section 2, we present the Risk Categories of the Application. In Section 3, we present the Value Table for Applicant Scoring. In Section 4, we present Thresholding for Approving Applicants. Other embodiments, features, and aspects of the disclosed system are described in detail herein and are considered a part of the claimed disclosed system. The methods and systems taught here help financiers reduce the time and cost of conducting due diligence on sellers in trade receivables financing transactions. It also minimizes losses associated with fraud and legal disputes. Most importantly, it opens access to the private company seller market to help bridge the $30 trillion gap between annual global trade and the financing market supporting it.

### BRIEF DESCRIPTION OF THE DRAWINGS

Here are some examples/embodiments:

FIG. 1 shows “General Schematic for Fraud Prevention in Trade Receivables Financings,” as an example.

FIG. 2 shows an example of a list of risk categories used to assess an applicant.

FIG. 3 shows an example of a value table used to calculate an applicant's score.

FIG. 4 illustrates the typical thresholding process for approving or rejecting an applicant.

FIG. 5 is a detailed visual of an iteration of the “receivables obligors” subcategory on the application.

FIG. 6 is a detailed visual of an iteration of the “servicing of receivables” subcategory on the application.

FIG. 7 shows an example of the maintenance protocol for the application.

### DETAILED DESCRIPTION

### Section 1: Application, Scoring, and Approval Process

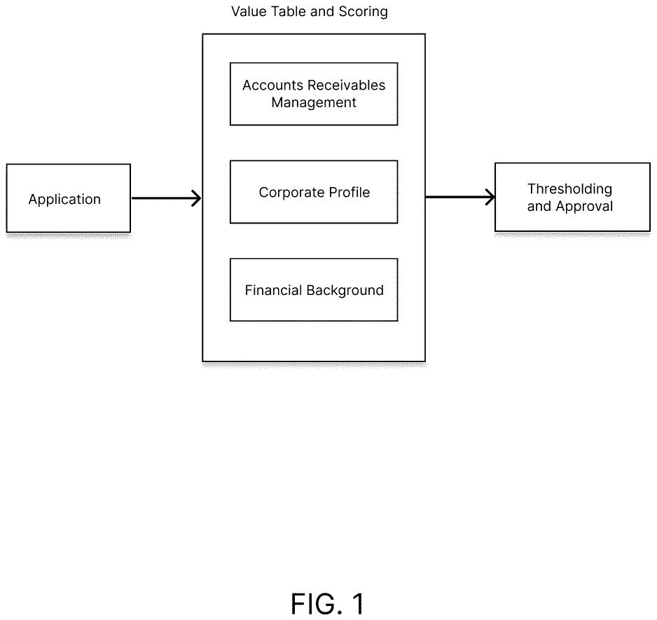

Section 1 presents the General Schematic for Fraud Prevention in Trade Receivables Financings, as an example (see FIG. 1). This framework, implemented and operated by a computing device, follows a three-step process of application, scoring, and approval to assess the likelihood that an applicant may attempt to defraud the financier or otherwise undermine the integrity of the trade receivables financing through non-performance, an outcome that would be treated as a form of fraud. The types of trade receivables financing structures include, but are not limited to: (a) “true sale” receivables purchase facilities with no recourse to the seller; (b) limited recourse receivables purchase facilities where the seller retains some risk of obligor non-payment; (c) full recourse receivables purchase facilities where the seller retains all risk of obligor non-payment; (d) asset-based loans where a borrower's trade receivables are secured as collateral against a loan; (e) securitizations and structured transactions where a seller's trade receivables are transferred to a bankruptcy-remote vehicle that are secured as collateral against funding by financiers; and (f) payables financing where a buyer coordinates early payment to a seller via a third-party financier and repays the financier under revised payment terms. All structures (a-f) follow the same core process shown in FIGS. 1-4. The types of asset classes include, but are not limited to: accounts, chattel paper, commercial tort claims, instruments, documents, general intangibles, letters of credit, and rights to payment (each, where applicable, as defined under UCC Article 9, and all following the same core process shown in FIGS. 1-4). A satisfactory score of the application generally results in approval to proceed with financing. In some cases, additional information may be required, or approval may come with conditions, or the financier may choose not to proceed, even if the applicant meets the score threshold.

### Section 2: Risk Categories of the Application

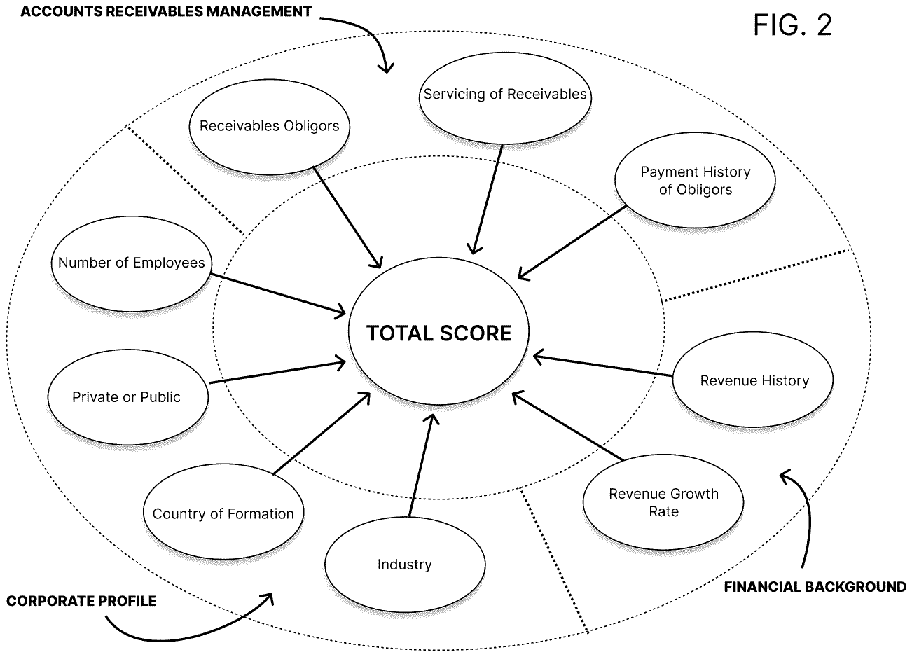

Section 2 explains the risk categories and subcategories for the scoring system of the application, as shown in FIG. 2. The first category looks at how the applicant manages its accounts receivables, particularly who its obligors are, the payment history of the obligors, and whether the applicant has successfully serviced (or collected) its receivables over time. The second category, corporate profile, looks at key company attributes, such as whether it is public or private, how many employees it has, the industry it operates in, and the country of formation. The third category focuses on the applicant's financial background, such as the applicant's revenue history and revenue growth rate. Specific data points may include the applicant's reported revenue from two years and one year ago, and the percentage change between those years.

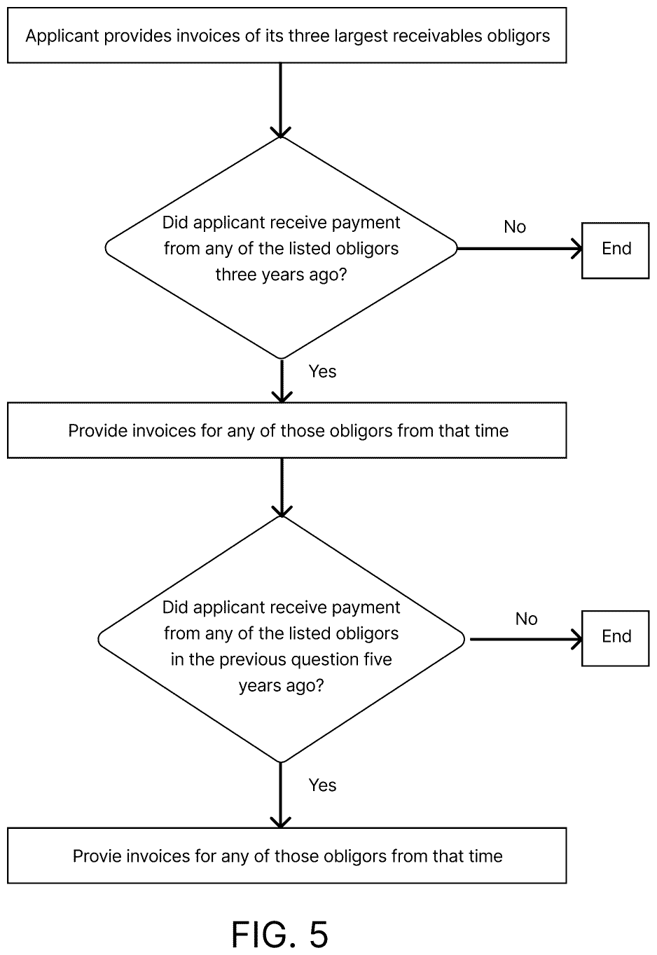

As part of the accounts receivables management category, the applicant may be asked to identify its three largest receivables obligors (by annual revenue, market capitalization, or other discretionary measures) by providing recent invoices, along with providing details about any payments made by those obligors over the past three, five, or other specified years (see FIG. 5). In other embodiments, the required number of obligors will vary. Generally, invoices must meet a minimum value of $100,000 per invoice. The application may require that the invoices be provided in PDF format, text, or other document formats. The invoices may also be verified using automatic authentication, manual review, or other methods.

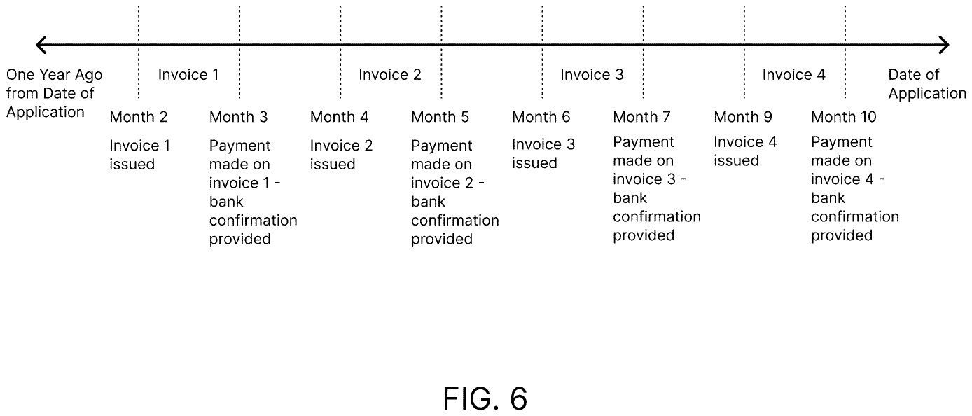

Further, the applicant may need to show that it successfully serviced receivables of upwards of eight obligors, or another appropriate number, over the past year. Applicant will generally need to provide: (a) at least four invoices issued to an obligor over the past year that are (i) dated at least two months apart, sequentially, and (ii) have a minimum value of $100,000 per invoice; (b) an agreement or contract connecting such invoices and shows the payment terms of the invoices; and (c) bank confirmations verifying that the invoices were paid within the agreed payment terms (see FIG. 6, showing an example of an obligor with net 30 day invoices). The application may require any invoices, agreements, or bank confirmations be provided in PDF format, text, or other document formats. The invoices, agreements, or bank confirmations may also be verified using automatic authentication, manual review, or other methods. In some embodiments, the risk categories and subcategories may vary, be more specific or broad, or omitted or newly introduced to ensure the applicant's score is being appropriately measured.

### Section 3: Value Table for Applicant Scoring

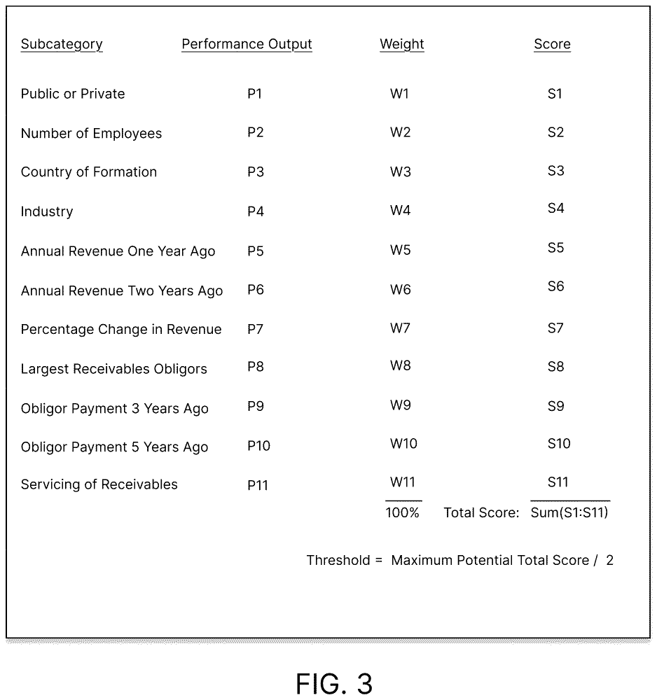

Section 3, shown in FIG. 3, describes the value table used to calculate an applicant's total score. The subcategories of Section 2 may have assigned weights along with performance outputs based on the applicant's response, both processed by a ranking and calculating device. The applicant's score for each subcategory is determined by multiplying the assigned weight by the performance output generated by the applicant's response. The assigned weight per subcategory may vary and the total for all assigned weights may equal 100% or another determined value. Likewise, the performance outputs may vary, such as on a scale of 0 or 1, 1-5, 1-3, or 1-1.5. After all subcategories are scored, the individual scores are added to get the applicant's total score.

Some subcategories may have specific eligibility criteria, such as a minimum revenue requirement. If the applicant fails to meet any of these conditions, the application may be automatically disqualified, or the subcategory may score zero.

### Section 4: Thresholding for Approving Applicants

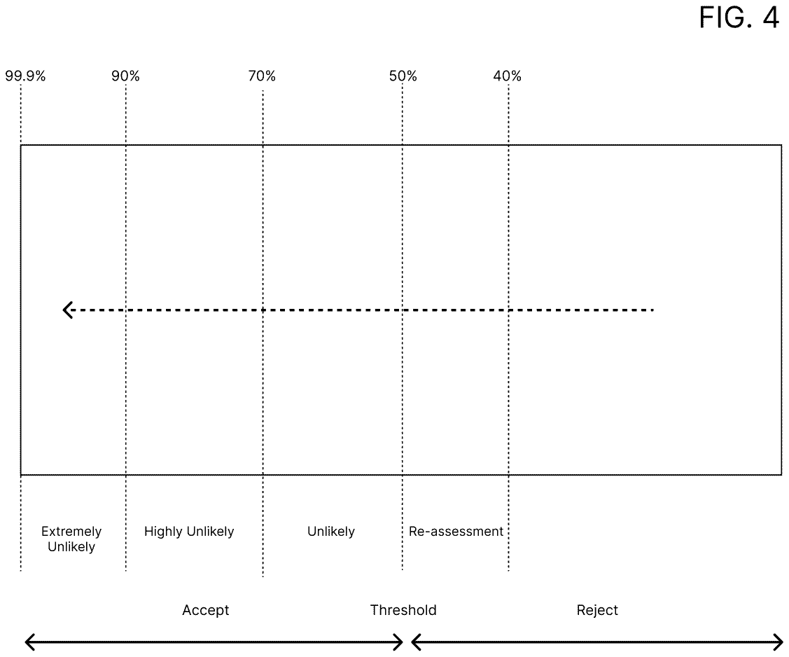

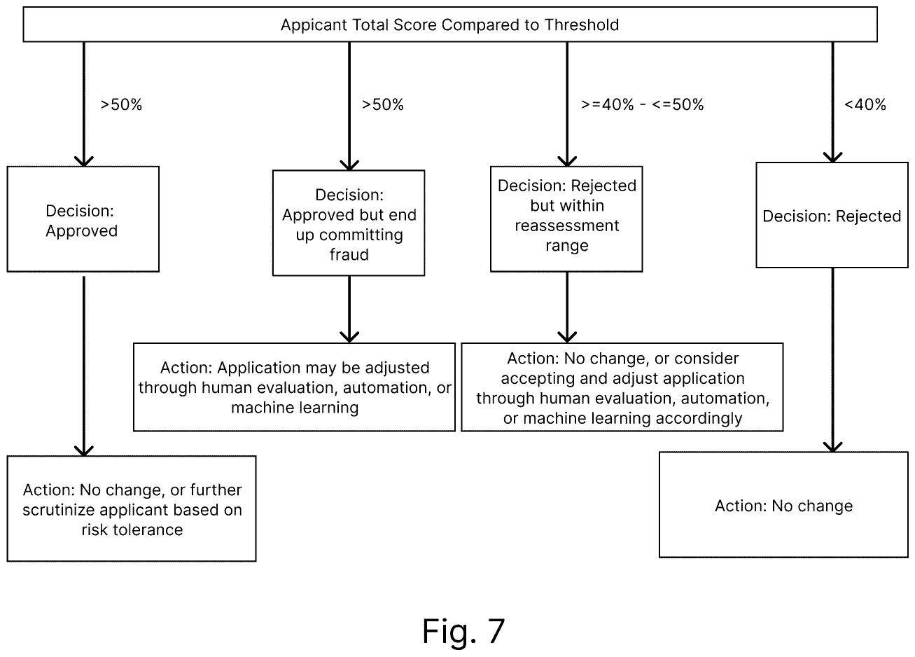

Section 4 explains the thresholding process, implemented by a processing device, to determine whether an application will be approved or rejected (as depicted in FIG. 4). The process typically starts by calculating the maximum potential total score from Section 3 and dividing that number by two (or another determined number) to set the threshold. This threshold represents a 50% likelihood that the applicant will defraud the financier or undermine the integrity of the financing. If the applicant's total score is above 50%, it suggests that the applicant is unlikely to commit fraud, and the application is approved. The threshold percentage may vary in some embodiments, and applications above this threshold may undergo further scrutiny based on the applicant's position in the risk ranges, such as 50%-70% (“unlikely”), 70%-90% (“highly unlikely”), or 90%-99.9% (“extremely unlikely”). Depending on the financier's risk tolerance, a limited number of applicants from each range may be approved. For example, accepting 9 out of 10 applicants in the “extremely unlikely” range and 7 out of 10 in the “unlikely” range instead of approving all applicants above the 50% threshold. If any accepted applicants commit fraud or undermine the integrity of the receivables financing transaction, the categories, subcategories, weights, performance outputs, or thresholds may be updated through human evaluation, automation, or machine learning to improve future assessments. (See FIG. 7).

Applicants whose scores fall below the 50% threshold are generally rejected. In some cases, as shown in FIG. 4, applicants in the 40%-50% range (or other determined range) may be re-assessed for acceptance. These applicants, once accepted, may also help to update the categories, subcategories, weights, performance outputs, or thresholds through human evaluation, automation, or machine learning to improve future assessments. (See FIG. 7).

The invention is claimed:

1. A computer-implemented method used for assessing fraud risk in trade receivables financings, said method comprising:
a computing device receiving an application, regarding an applicant, comprising risk categories, including subcategories, of an applicant's accounts receivables management, corporate profile, and financial background;
a ranking and calculating device assigning weights to said risk categories;
said ranking and calculating device assigning performance outputs to said risk categories based on applicant responses;
combining the three parameters of said risk categories, said assigned weights, and said assigned performance outputs to calculate a total score for said applicant; and
approving or rejecting said application for said applicant, by a processing device, based on said applicant's total score and one or more of the parameters used to calculate the applicant's total score.

2. The method of claim 1, wherein said method comprises the following trade receivables financing structures: true sale receivables purchase facilities, limited recourse receivables purchase facilities, full recourse receivables purchase facilities, trade receivables asset-based loans, trade receivables securitizations, payables financings, and trade receivables structured transactions.

3. The method of claim 1, wherein said method comprises the following assets: accounts, chattel paper, commercial tort claims, instruments, documents, general intangibles, letters of credit, and rights to payment.

4. The method of claim 1, wherein said method considers one or more of the following of the applicant: private or public, country of formation, industry, number of employees, revenue history, revenue growth rate, receivables obligors, payment history of obligors, and servicing of receivables.

5. The method of claim 1, wherein said method considers one or more of the following: updating said assigned weights, said assigned performance outputs, or said risk categories or subcategories or thresholds based on human evaluation, automation, or machine learning principles.
